(19) United States
(12) Patent Application Publication
(10) Pub. No.: US 2009/0051815 A1
(43) Pub. Date: Feb. 26, 2009

(54) Signal Processing Device and Optical Disc Apparatus

(76) Inventor: Tadayoshi Ishikawa, Kyoto (JP)

Correspondence Address: MCDERMOTT WILL & EMERY LLP, 600 13TH STREET, NW, WASHINGTON, DC, 20005-3096, US

(21) Appl. No.: 11/886,741

(22) PCT Filed: Jan. 15, 2007
(86) PCT No.: PCT/JP2007/050418

§ 371 Date: Sep. 20, 2007

(30) Foreign Application Priority Data
Jan. 17, 2006 (JP) 2006-008466
Apr. 26, 2006 (JP) 2006-121524

(51) Int. Cl. H04N 9/74; H04N 5/00

(52) U.S. Cl. 348/589; 386/126; 348/E09.055; 386/E05.064

(57) ABSTRACT

A video decoder 107 decodes an inputted video signal to output video information. A microcomputer 108 reads only specific compressed font data from a ROM 104 in which compressed font data is stored, decompresses the read compressed font data sequentially and stores the decompressed font data into a RAM 105. The microcomputer 108 also generates information to be superimposed on the video information by combining decompressed font data and stores the superimposition information into the RAM 105. A video synthesis section 111 superimposes the superimposition information stored in the RAM 105 on the video information.

### TECHNICAL FIELD

The present invention relates to a signal processing device for performing video processing for display of information such as characters on a display screen, and more particularly to a signal processing device for on screen display (OSD).

### BACKGROUND ART

In recent years, many large-scale system LSIs (large-scale integrated circuits) have been developed. As peripheral LSIs of such system LSIs, mounted are large-capacity memories such as flash memories in which software for system control is installed and SDRAMs (synchronous dynamic random access memories) into which data required in data processing and data processing results are sequentially stored.

Such systems are in widespread use as audio and video processing devices. For example, such systems have been adopted as digital signal processing devices for output/playback of audio/video information (contents information) recorded on an optical disc such as a DVD (digital versatile disc), and as signal processing devices for processing various kinds of character information displayed on a screen.

The technology of displaying character information on a screen by superimposing the character information on a playback image is generally called OSD. Examples of character information displayed by OSD include system-generated information independent of contents, such as information indicating the current time, and contents-related information including information generated based on a signal read from a disc, such as information indicating the playback time of contents read from an optical disc.

As devices for performing screen display by OSD, known are devices in which a display material memory is provided for holding therein a character font set and patterns of images serving as materials for a display screen, and specific characters and a specific image pattern are read from the display material memory and combined to make up an image for OSD display (see Patent Literature 1, for example).

The character font set and image patterns used in such devices require a large memory capacity. In some devices, therefore, a compressed font set is held in a ROM (read-only memory) in advance, and data in the ROM is decompressed at the time of use, to thereby reduce the capacity of the ROM (see Patent Literature 2, for example).

### Patent Literature 1: Japanese Laid-Open Patent Publication No. 2000-23061

### Patent Literature 2: Japanese Laid-Open Patent Publication No. 2004-272090

### DISCLOSURE OF THE INVENTION

### Problems to be Solved by the Invention

In recent years, DVD players and the like having a signal processing device for OSD display increasingly tend to display character information corresponding to a plurality of languages, display character information at high level of gradation and display an increased number of characters in response to a more sophisticated display screen. For these reasons, the amount of OSD data for OSD display tends to increase resulting in increase of the capacity of a RAM (random access memory) in which OSD data is temporarily stored. Also, in devices in which a compressed font set is held in a ROM, it is required to secure a decompressed font storage region in the RAM sufficiently for temporarily storing decompressed font data.

Meanwhile, with DVD players and the like increasingly becoming lower in price, the RAM capacity of peripheral LSIs tends to be reduced. In other words, there arises a problem that although a larger RAM capacity is required for higher-level OSD, the memory capacity tends to be reduced.

In view of the above problem, an object of the present invention is providing a signal processing device capable of performing processing of information to be superimposed on video information properly with a RAM capacity smaller than that required if the entire character font set is stored in the RAM.

### Means for Solving the Problems

To solve the problem described above, the present invention is directed to a signal processing device for performing signal processing for display of predetermined information on a display screen by superimposing the predetermined information on video information, the device including:

a video decoder for decoding an inputted video signal to output the video information;

a microcomputer for reading specific compressed font data from a ROM in which compressed font data is stored, decompressing the read compressed font data sequentially and storing the decompressed font data into a RAM, the microcomputer also generating superimposition information to be superimposed on the video information by combining font data stored in the RAM and storing the superimposition information into the RAM; and

a video synthesis section for superimposing the superimposition information stored in the RAM on the video information.

In an embodiment of the present invention, in the signal processing device described above, only font data corresponding to character data required for display of the superimposition information is decompressed and stored in the RAM.

In another embodiment of the present invention, in the signal processing device described above, only font data corresponding to character data high in use frequency is decompressed and stored in the RAM.

With the configurations described above, processing of information to be superimposed on video information can be performed properly even if the RAM capacity is reduced.

Alternatively, in the signal processing device described above, after compressed font data is decompressed sequentially, the font is not stored in the RAM but is combined directly to generate superimposition information to be superimposed on the video information and store the generated information in the RAM.

With the configuration described above, processing of information to be superimposed on video information can be performed properly even if the font storage capacity of the RAM is reduced.

According to another aspect of the invention, an optical disc apparatus including the signal processing device described above is provided.

It is therefore possible to provide an optical disc apparatus capable of performing processing of information to be superimposed on video information properly even if the RAM capacity is reduced.

### EFFECT OF THE INVENTION

According to the present invention, only font data minimum required for display of information to be superimposed on video information may be decompressed and stored in a RAM. This makes it possible to perform processing of information to be superimposed on video information properly with a RAM capacity smaller than that required if the entire character font set is stored in the RAM.

### BRIEF DESCRIPTION OF THE DRAWINGS

FIG. 1 is a block diagram of an optical disc apparatus using a signal processing device of the present invention.

FIG. 2 is a flowchart showing an operation of reading compressed font data stored in a ROM and storing the data into a RAM in Embodiment 1.

FIG. 3 is a flowchart showing VRAM data generation processing in Embodiment 1.

FIG. 4 is a flowchart showing an operation of reading compressed font data stored in a ROM and storing the data into a RAM in Embodiment 2.

FIG. 5 is a flowchart showing VRAM data generation processing in Embodiment 2.

FIG. 6 is a flowchart showing VRAM data generation processing in Embodiment 3.

### DESCRIPTION OF REFERENCE NUMERALS

100 Optical disc apparatus
101 Optical disc
102 Optical pickup
103 A/D conversion section
104 ROM
104a Compressed font storage region
105 RAM
105a Decompressed font storage region
105b VRAM region
106 System decoder
107 Video decoder
108 Microcomputer
109 Internal RAM
110 DMA controller
111 Video synthesis section
112 D/A conversion section
113 Display output section
114 System LSI

### BEST MODE FOR CARRYING OUT THE INVENTION

Hereinafter, embodiment of the present invention will be described with reference to the accompanying drawings.

### Embodiment 1

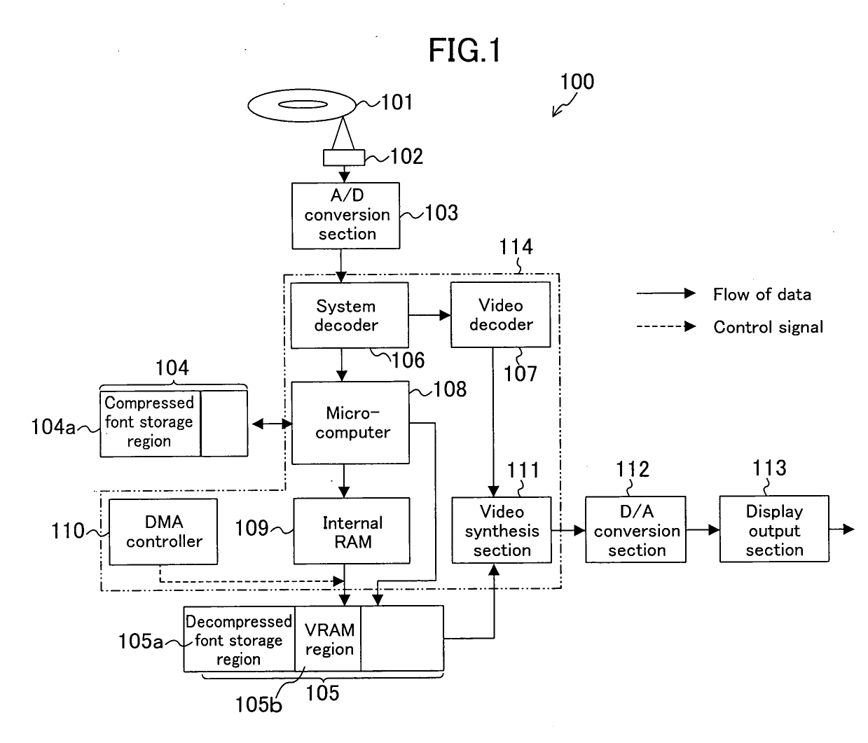

FIG. 1 is a block diagram of an optical disc apparatus 100 using a signal processing device of the present invention. The optical disc apparatus 100 plays back audio/video information (contents information) recorded on an optical disc, and also displays information such as various kinds of character information by superimposing such information on the video information. Hereinafter, superimposition display of information on video information is called OSD display. Examples of information to be OSD-displayed (superimposition information) include characters, numbers and codes.

Referring to FIG. 1, the reference numeral 101 denotes an optical disc on which contents information such as audio/video information is recorded.

The reference numeral 102 denotes an optical pickup for irradiating the optical disc 101 with laser light, receiving light reflected from the optical disc 101 and converting the received light to an analog signal.

The reference numeral 103 denotes an A/D conversion section for converting the analog signal generated by the optical pickup 102 to a digital signal.

The reference numeral 104 denotes a ROM, in which compressed font data is stored.

The reference numeral 105 denotes a RAM, which includes a decompressed font storage region 105a where decompressed font data (to be described later) is stored and a VRAM (video RAM) region 105b where data for OSD display (i.e., superimposition information) is stored.

The reference numeral 106 denotes a system decoder for extracting a video signal and an audio signal from the digital signal generated by the A/D conversion section 103. The system decoder 106 also extracts management information such as the playback start time (PTS) and decoding start time (DTS) of contents recorded on the optical disc 101.

The reference numeral 107 denotes a video decoder for decoding the video signal extracted by the system decoder 106.

The reference numeral 108 denotes a microcomputer for generating data for OSD display based on the management information extracted by the system decoder 106. To state more specifically, the microcomputer 108 reads font data required for generation of data for OSD display from a compressed font storage region 104a, decompresses the read font data and then stores the decompressed font data into the decompressed font storage region 105a. The microcomputer 108 further generates data for OSD display with reference to the decompressed font storage region 105a. Assume in this embodiment that the microcomputer 108 can store data into an internal RAM 109 faster than into the RAM 105.

The reference numeral 109 denotes the internal RAM in which data for OSD display generated by the microcomputer 108 is stored.

The reference numeral 110 denotes a direct memory access (DMA) controller for controlling DMA transfer of data for OSD display from the internal RAM 109 to the VRAM region 105b.

The reference numeral 111 denotes a video synthesis section for generating digital data to be displayed on a display screen. To state in more detail, the video synthesis section 111 reads data for OSD display stored in the RAM 105 and video data decoded by the video decoder 107, superimposes the data for OSD display on the video data, and outputs the resultant data.

The reference numeral 112 denotes a D/A conversion section for converting the digital data generated by the video synthesis section 111 to an analog signal.

The reference numeral 113 denotes a display output section for allowing images to be displayed on a display (not shown) based on the analog signal generated by the D/A conversion section 112.

In the optical disc apparatus 100 described above, the system decoder 106, the video decoder 107, the microcomputer 108, the internal RAM 109, the DMA controller 110 and the video synthesis section 111 constitute a system LSI 114, and the other circuits exist as peripheral LSIs.

Hereinafter, the OSD information processing operation of the optical disc apparatus 100 will be described.

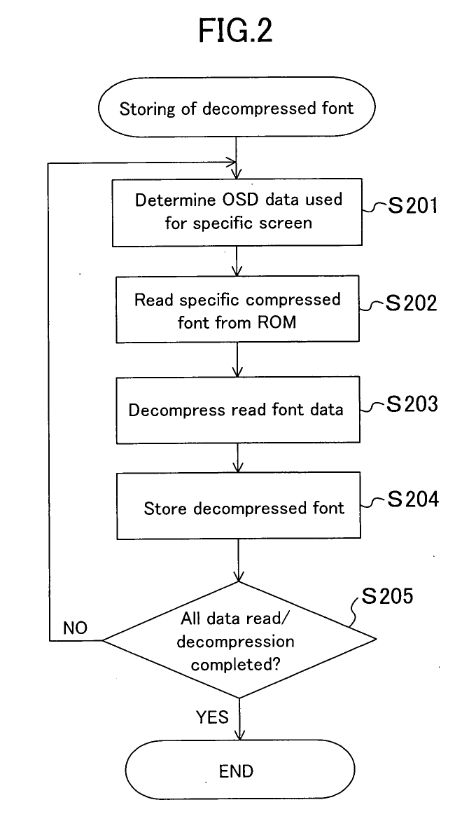

FIG. 2 is a flowchart showing an operation of storing an OSD font required for OSD display, among the compressed font data stored in the ROM 104, into the decompressed font storage region 105a of the RAM 105.

First, the microcomputer 108 determines all of OSD data used for OSD display of one screen according to an external instruction (S201).

Once determining the OSD data, the microcomputer 108 reads one of a plurality of compressed fonts corresponding to the determined OSD data from the compressed font storage region 104a of the ROM 104 (S202).

The microcomputer 108 decompresses the compressed font read from the ROM 104 (S203).

The microcomputer 108 stores the decompressed font data temporarily into the internal RAM 109, and then into the decompressed font storage region 105a of the RAM 105 under the control of the DMA controller 110 (S204). Note that the microcomputer may directly transfer the decompressed font data without use of the DMA controller.

The microcomputer 108 then judges whether or not all of the font data required for OSD display has been decompressed. If all of the font data has not been decompressed, the processing of steps S201 through S204 is repeated, to sequentially decompress compressed font data. If all of the font data has been decompressed, the processing is terminated (S205).

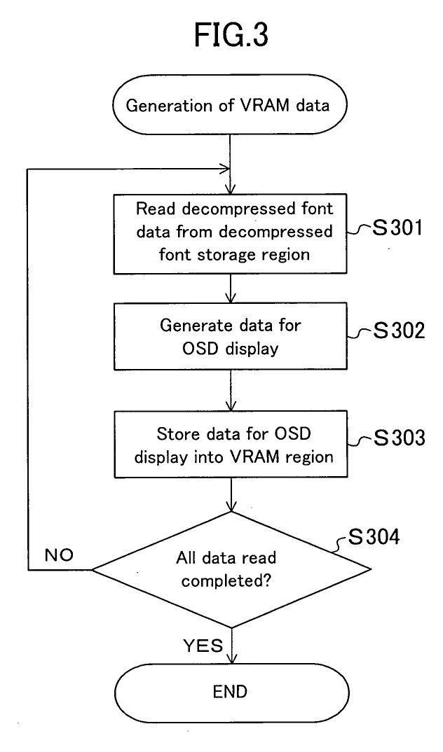

Thereafter, the microcomputer 108 generates data for OSD display (VRAM data) using the font data stored in the decompressed font storage region 105a. FIG. 3 is a flowchart of VRAM data generation processing.

First, the microcomputer 108 reads font data required for display of OSD data from the decompressed font storage region 105a (S301).

The microcomputer 108 then generates data for OSD display to be superimposed on video information using the read font data (S302).

The microcomputer 108 stores the generated data for OSD display into the VRAM region 105b of the RAM 105 (S303).

The microcomputer 108 then judges whether or not all of the data for OSD display required for the OSD display has been transferred to the VRAM region 105b. If all of the data for OSD display has not been transferred, the processing of steps S301 through S303 is repeated, to sequentially transfer font data. If all of the font data has been transferred, the processing is terminated (S304).

Note that detailed description is omitted on the processing of reading information recorded on the optical disc 101 with the optical pickup 102 and the A/D conversion section 103, the processing of extracting a video signal, management information and the like from the read information with the system decoder 106, and the processing of superimposing data for OSD display on video data decoded with the video decoder 107 and displaying/outputting the resultant data, which are all conventionally known. It should also be noted that description is omitted on the processing of an audio signal extracted with the system decoder 106 because this is not directly related to the present invention.

As described above, in this embodiment, it is only necessary to decompress font data minimum required for OSD display and store the decompressed data in the RAM 105. This permits OSD processing with a RAM capacity smaller than that required if the entire character font set is stored in the RAM.

### Embodiment 2

Next, Embodiment 2 will be described. The apparatus of Embodiment 2 is the same as the optical disc apparatus 100 of Embodiment 1 in circuit configuration, but is different therefrom in the operation of the microcomputer 108.

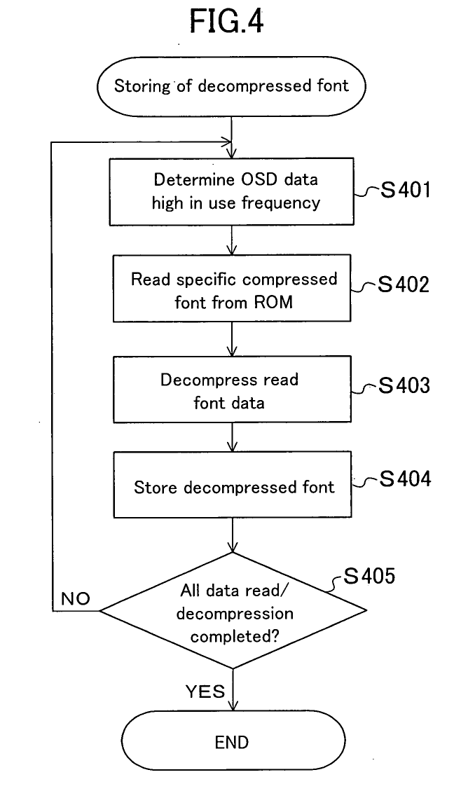

FIG. 4 is a flowchart showing an operation of reading compressed font data stored in the ROM 104 and storing the read data into the decompressed font storage region 105a of the RAM 105. In this embodiment, font data used for OSD data high in use frequency is decompressed and stored in the decompressed font storage region 105a.

First, the microcomputer 108 determines OSD data high in use frequency in its initialization processing (S401).

Once determining OSD data high in use frequency, the microcomputer 108 reads one of a plurality of compressed font data corresponding to the determined OSD data from the compressed font storage region 104a of the ROM 104 (S402).

The microcomputer 108 decompresses the read compressed font data (S403).

The microcomputer 108 stores the decompressed font data temporarily into the internal RAM 109, and then into the decompressed font storage region 105a of the RAM 105 under the control of the DMA controller 110 (S404). Note that the microcomputer may directly transfer the decompressed font data without use of the DMA controller.

The microcomputer 108 then judges whether or not all of the determined font data has been decompressed. If all of the font data has not been decompressed, the processing of steps S401 through S404 is repeated, to sequentially decompress compressed font data. If all of the font data has been decompressed, the processing is terminated (S405).

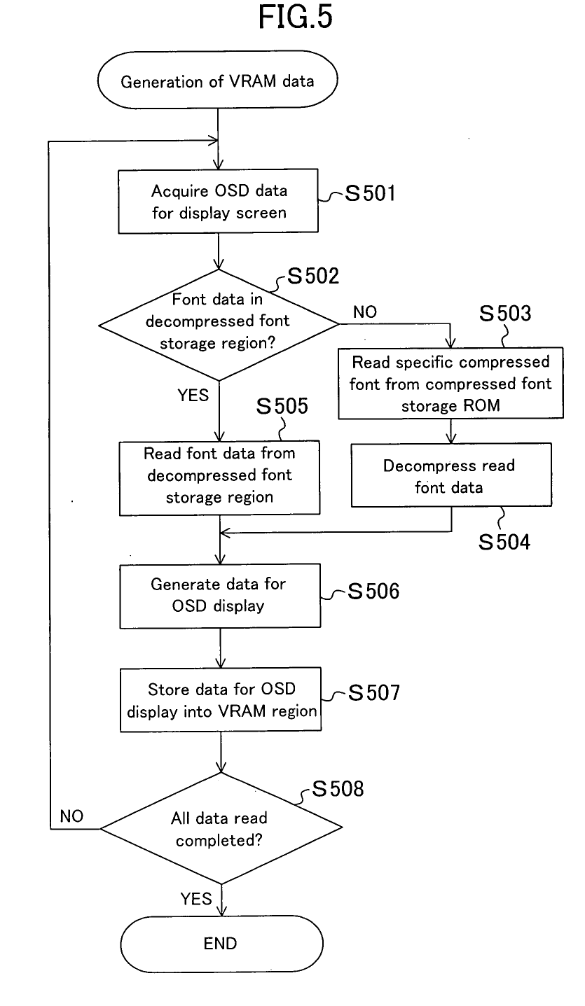

Thereafter, the microcomputer 108 generates data for OSD display (VRAM data) using the font data stored in the decompressed font storage region 105a or in the compressed font storage region 104a. FIG. 5 is a flowchart of VRAM data generation processing.

First, the microcomputer 108 acquires OSD data to be displayed as OSD (S501).

The microcomputer 108 judges whether font data corresponding to the acquired OSD data is in the decompressed font storage region 105a or in the compressed font storage region 104a (S502).

If font data corresponding to the acquired OSD data is in the compressed font storage region 104a, the microcomputer 108 reads corresponding compressed font data from the compressed font storage region 104a (S503). The microcomputer 108 further decompresses the compressed font data read from the ROM 104 (S504).

If font data corresponding to the acquired OSD data is in the decompressed font storage region 105a, the microcomputer 108 reads corresponding decompressed font data from the decompressed font storage region 105a (S505).

The microcomputer 108 then generates data for OSD display to be superimposed on video information using the decompressed font data (S506). The microcomputer 108 stores the generated data for OSD display into the VRAM region 105b of the RAM 105 (S507).

The microcomputer 108 judges whether or not all of the font data required for OSD display has been transferred to the VRAM region 105b. If all of the font data has not been transferred, the processing of steps S501 through S507 is repeated, to sequentially transfer font data. If all of the font data has been transferred, the processing is terminated (S508).

Note that as in Embodiment 1, detailed description is omitted on the processing of reading information recorded on the optical disc 101 with the optical pickup 102 and the A/D conversion section 103, the processing of extracting a video signal, management information and the like from the read information with the system decoder 106, and the processing of superimposing data for OSD display on video data decoded with the video decoder 107 and displaying/outputting the resultant data, which are all conventionally known.

As described above, in this embodiment, it is only necessary to decompress font data corresponding to OSD data high in use frequency, among the font data minimum required for OSD display, and store the decompressed data in the RAM 105. This permits OSD processing with a RAM capacity smaller than that required if the entire character font set is stored in the RAM.

### Embodiment 3

Next, Embodiment 3 will be described. The apparatus of Embodiment 3 is the same as the optical disc apparatus 100 of Embodiment 1 in circuit configuration, except that the decompressed font storage region 105a of the RAM 105 is not used, and is different therefrom in the operation of the microcomputer 108.

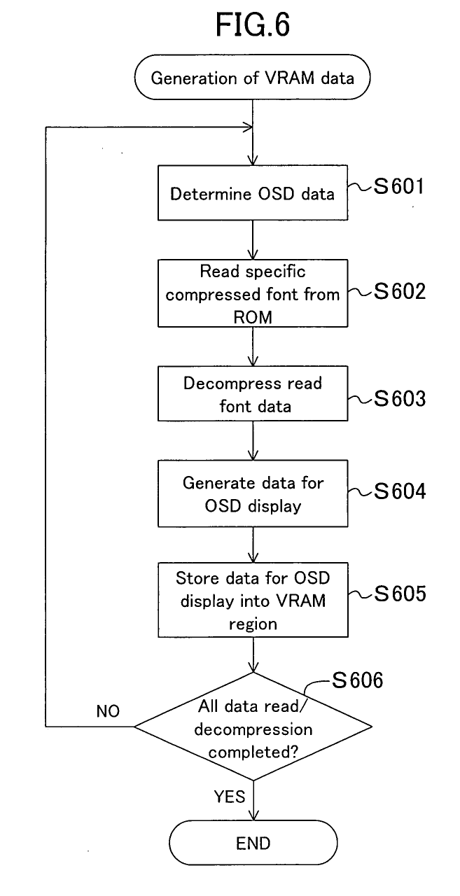

FIG. 6 is a flowchart of VRAM data generation processing in which OSD data to be superimposed on video information is generated based on compressed font data stored in the ROM 104 and stored in the VRAM region in the VRAM region 105b.

First, the microcomputer 108 determines OSD data to be displayed by OSD on a display screen according to an external instruction (S601). Once determining the OSD data, the microcomputer 108 reads one of a plurality of compressed fonts corresponding to the determined OSD data from the compressed font storage region of the ROM 104 (S602). The microcomputer 108 decompresses the compressed font read from the ROM 104 (S603).

In this embodiment, the microcomputer 108 does not store the decompressed font data into the RAM 105 but holds it therein. As a way of holding the data, the decompressed font data may be temporarily stored in a register provided inside the microcomputer 108. The microcomputer 108 then generates data for OSD display to be superimposed on video information using the decompressed data (S604). Thereafter, the microcomputer 108 stores the generated data for OSD display into the VRAM region of the RAM 105 under control of the DMA controller 110 (S605). Note that the microcomputer may directly transfer the data without use of the DMA controller. The microcomputer 108 then judges whether or not all of the font data required for OSD display has been decompressed. If all of the font data has not been decompressed, the processing of steps S601 through S605 is repeated, to sequentially decompress compressed font data. If all of the font data has been decompressed, the processing is terminated (S606).

As described above, in this embodiment, in which the decompressed font data decompressed by the microcomputer 108 is not stored in the RAM 105, it is unnecessary to secure the decompressed font storage region 105a in the RAM 105. This makes it possible for a system small in RAM capacity to perform high-function OSD processing.

In the above embodiments, the system decoder 106, the video decoder 107, the microcomputer 108, the internal RAM 109, the DMA controller 110 and the video synthesis section 111 constitute the system LSI 114. The present invention is not necessarily limited to this configuration to exert its technical function and effect. For example, substantially the same technical function and effect can be obtained with a configuration in which the A/D conversion section 103, the ROM 104, the RAM 105, the D/A conversion section 112 and the like are incorporated in the system LSI 114.

As the ROM 104, a flash ROM as a rewritable nonvolatile memory is preferably used. As the RAM 105, a comparatively inexpensive SDRAM is preferably used.

Although the signal processing device of the present invention was applied to an optical disc apparatus in the above embodiments, it is also applicable to a broadcast receiving apparatus such as a TV set. In the latter case, a video signal may be extracted from a broadcast radio wave, and character information and the like may be superimposed on the video signal.

### INDUSTRIAL APPLICABILITY

According to the signal processing device of the present invention, only font data minimum required for display of information to be superimposed on video information may be decompressed and stored in a RAM. The inventive signal processing device therefore has the effect of permitting processing of information to be superimposed on video information properly with a RAM capacity smaller than that required of the entire character font set is stored in the RAM. Accordingly, the present invention is useful as a signal processing device and the like for performing video processing for display of information such as characters on a display screen, and particularly, as a device for signal processing for OSD.

1. A signal processing device for performing signal processing for display of predetermined information on a display screen by superimposing the predetermined information on video information, the device comprising:
a video decoder for decoding an inputted video signal to output the video information;
a microcomputer for reading specific compressed font data from a ROM in which compressed font data is stored, decompressing the read compressed font data sequentially and storing the decompressed font data into a RAM, the microcomputer also generating superimposition information to be superimposed on the video information by combining font data stored in the RAM and storing the superimposition information into the RAM; and
a video synthesis section for superimposing the superimposition information stored in the RAM on the video information.

2. The signal processing device of claim 1, wherein only font data corresponding to character data required for display of the superimposition information is decompressed and stored in the RAM.

3. The signal processing device of claim 1, wherein only font data corresponding to character data high in use frequency is decompressed and stored in the RAM.

4. A signal processing device for performing signal processing for display of predetermined information on a display screen by superimposing the predetermined information on video information, the device comprising:
a video decoder for decoding an inputted video signal to output the video information;
a microcomputer for reading a plurality of required compressed font information units from a ROM in which compressed font data is stored, decompressing the plurality of read compressed font information units sequentially, generating information to be superimposed on the video information outputted from the video decoder by combining the plurality of decompressed font information units, and storing the generated information into the RAM; and
a video synthesis section for superimposing the information stored in the RAM on the video information outputted from the video decoder.

5. An optical disc apparatus comprising the signal processing device of claim 1.

6. An optical disc apparatus comprising the signal processing device of claim 4.
